(19) United States
(12) Patent Application Publication
(10) Pub. No.: US 2025/0269925 A1
(43) Pub. Date: Aug. 28, 2025

(54) FOLDING TYPE ELECTRIC KICKBOARD USING LINEAR ACTUATOR

(71) Applicant: BOKYONG CO., LTD., Gyeonggi-do (KR)

(72) Inventor: Bok Yong HONG, Gyeonggi-do (KR)

(21) Appl. No.: 18/010,298

(22) PCT Filed: Dec. 3, 2021
(86) PCT No.: PCT/KR2021/018209

§ 371 Date: Dec. 14, 2022

(30) Foreign Application Priority Data
Nov. 30, 2021 (KR) 10-2021-0168142

(51) Int. Cl. B62K 15/00; B62K 11/02; B62K 21/02

(52) U.S. Cl. CPC B62K 15/008; B62K 11/02; B62K 2202/00

(57) ABSTRACT

A folding type electric kickboard, which includes a frame folding portion (30) to which a front wheel (W1) and a rear wheel (W2) are mounted, a steering post (40-5) connected to the front wheel (W1), and a handle formed on the top of the steering post (40-5), wherein the frame folding portion (30) includes one side frame (30-1) and the other side frame (30-2), a hinge (6) is formed at a boundary between the one side frame (30-1) and the other side frame (30-2), a folding electric cylinder (30-8) is attached to the one side frame (30-1), a connecting member (5) is connected to a tip of a cylinder rod of the folding electric cylinder (30-8) and the connecting member (5) is attached to the other side frame (30-2), and a bottom surface of the other side frame (30-2) is formed with a connecting base mounting portion (54).

### BACKGROUND

The present invention relates to a folding type electric kickboard using a linear actuator, and more particularly, a folding type electric kickboard that can be quickly and conveniently driven by electric power and can be folded and stored using a linear actuator.

In general, an electric kickboard is provided so that it can be automatically moved while riding on a board in a standing state and used for purposes such as a means of transportation, exercise, or hobby, and is equipped with moving wheels mounted on a board on which a passenger can stand with both feet thereon, and a handle provided on a post of a fixed height so that the passenger can drive it.

Such an electric kickboard has driving means including a motor or the like electrically connected to the board side, and can be automatically moved by driving the moving wheels with the driving means.

However, in many cases, the conventional electric kickboards fold a vertical steering post horizontally and reduce only the height to add ease of handling, and when carrying it after reduction or moving it while wearing using a shoulder strap, there is an inconvenience of handling due to the weight, and there is an inconvenience due to contact with dirt in case of rain.

### SUMMARY OF THE INVENTION

The present invention relates to an electric kickboard, and is intended to improve the inventor's prior Patent No. 10-2251894. An object of the present invention is to provide a folding type electric kickboard in which a kickboard frame is easily folded in an ‘A’ type using an electric cylinder, a length of a handle is minimized, a steering handle post can also be tilted using an electric cylinder, the steering handle is folded by 90° to be parallel to a ground, a direction is guided with only one hand when moving to be freely steerable, a comfortable movement and an easy storage in a narrow location are possible, and linked boarding of a public transportation is easy.

The object of the present invention can be achieved by a folding type electric kickboard, including a frame folding portion to which a front wheel and a rear wheel is mounted, a steering post connected to the front wheel, and a handle formed on the top of the steering post, which is characterized in that the frame folding portion includes one side frame and the other side frame, a hinge is formed at a boundary between the one side frame and the other side frame, a folding electric cylinder is attached to the one side frame as a center a rear side in a horizontal direction, a connecting member is connected to a tip of a cylinder rod of the folding electric cylinder with an axial pin and the connecting member is attached to the other side frame, and a bottom surface of the other side frame is formed with a connecting base mounting portion having a large number of coupling holes so that a position to which the connecting member is fixed is settable.

According to the present invention, there are effects in which a kickboard frame is folded in an ‘A’ type to minimize a length, a steering handle post can also be tilted, and a steering handle is folded, so that a direction is guided with only one hand when moving to be freely steerable, a comfortable movement and an easy storage in a narrow location are possible, and linked boarding of a public transportation is easy.

### BRIEF DESCRIPTION OF DRAWINGS

FIG. 1 is a perspective view showing an unfolded state of a folding type electric kickboard using a linear actuator according to the present invention.

FIG. 2 is a side view showing an unfolded state of a folding type electric kickboard using a linear actuator according to the present invention.

FIG. 3 is a perspective view from below showing an unfolded state of a folding type electric kickboard using a linear actuator according to the present invention.

FIG. 4 is an exploded perspective view of a folding type electric kickboard using linear actuators according to the present invention, when viewed from below.

FIG. 5 is a side view showing a folded state of a folding type electric kickboard using a linear actuator according to the present invention.

FIG. 6 is a perspective view showing a state in which the frame folding portion of a folding type electric kickboard using a linear actuator according to the present invention is unfolded, when turned upside down.

FIG. 7 is a perspective view of the folding type electric kickboard using the linear actuator according to the present invention, in which the frame folding portion is folded upside down.

FIG. 8 is an exploded perspective view showing a steering post of a folding type electric kickboard using a linear actuator according to the present invention.

FIG. 9 is a diagram showing the folding operation of the steering post of the folding type electric kickboard using the linear actuator according to the present invention.

FIG. 10 is a diagram showing the “steering shaft housing support base 30-3” of the folding type electric kickboard using the linear actuator according to the present invention.

### DETAILED DESCRIPTION OF THE INVENTION

Preferred embodiments of the present invention will be described in detail below with reference to the accompanying drawings.

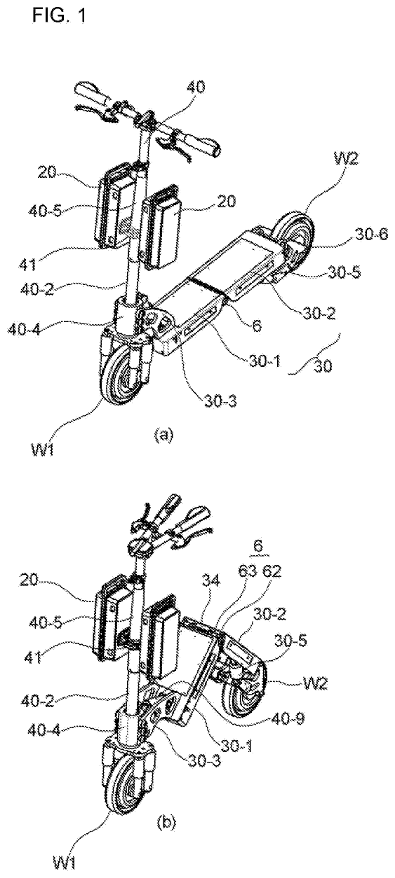

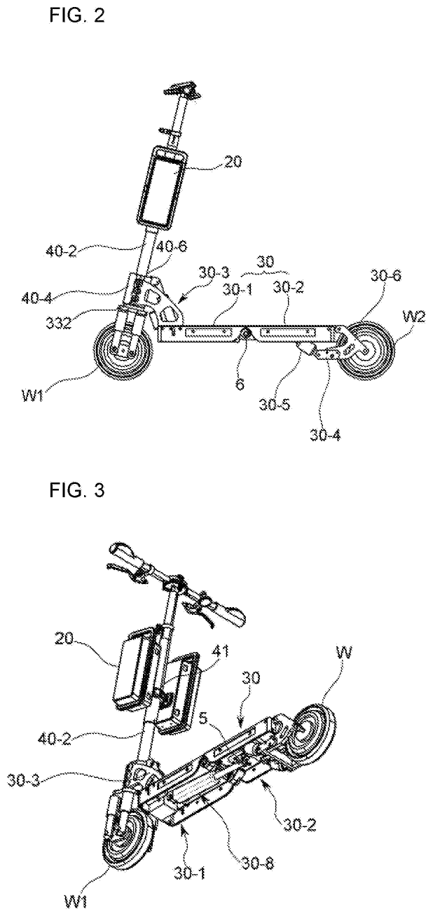

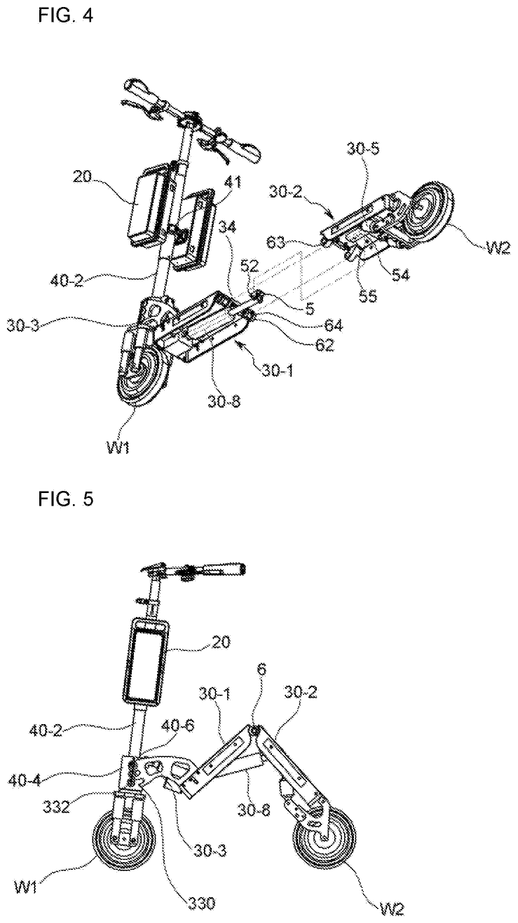

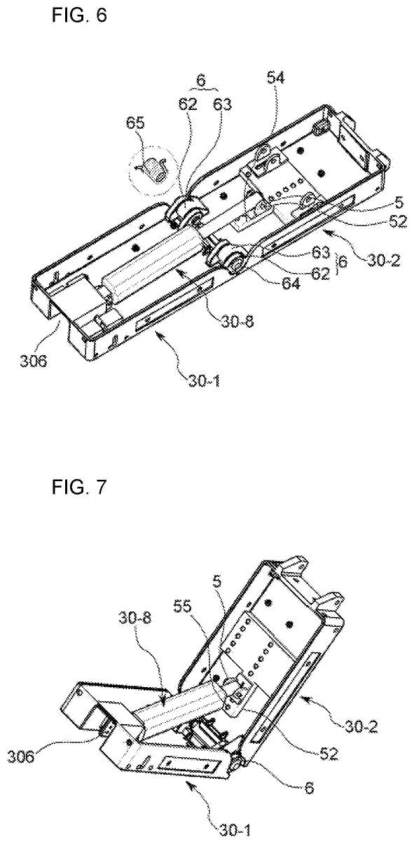

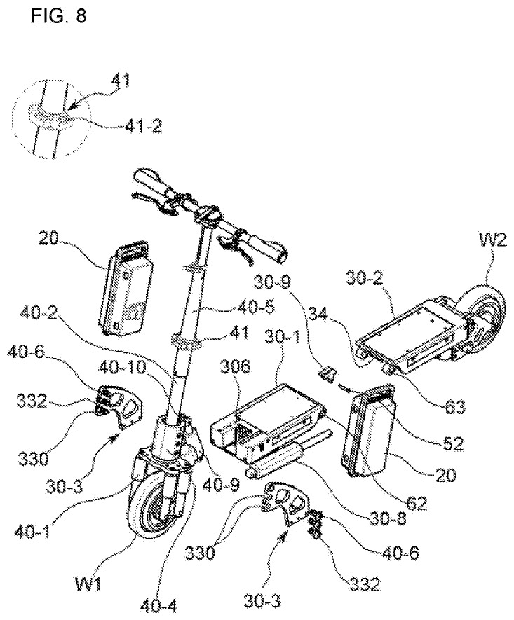

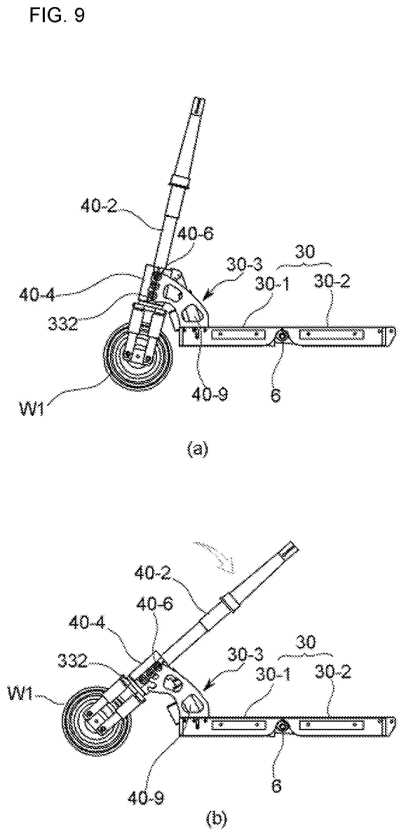

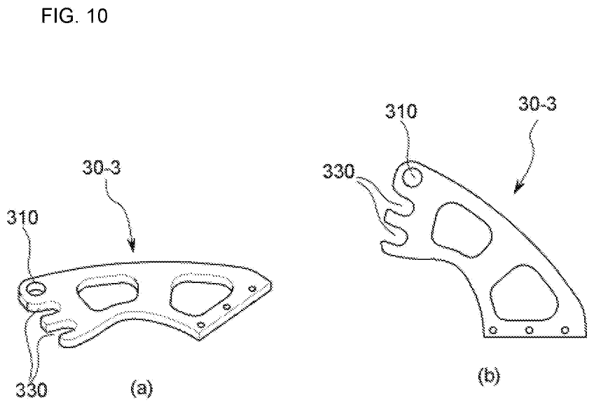

Among the accompanying drawings, FIG. 1 is a perspective view showing an unfolded state of a folding type electric kickboard using a linear actuator according to the present invention. FIG. 2 is a side view showing an unfolded state of a folding type electric kickboard using a linear actuator according to the present invention. FIG. 3 is a perspective view from below showing an unfolded state of a folding type electric kickboard using a linear actuator according to the present invention. FIG. 4 is an exploded perspective view of a folding type electric kickboard using linear actuators according to the present invention, when viewed from below. FIG. 5 is a side view showing a folded state of a folding type electric kickboard using a linear actuator according to the present invention. FIG. 6 is a perspective view showing a state in which the frame folding portion of a folding type electric kickboard using a linear actuator according to the present invention is unfolded, when turned upside down. FIG. 7 is a perspective view of the folding type electric kickboard using the linear actuator according to the present invention, in which the frame folding portion is folded upside down. FIG. 8 is an exploded perspective view showing a steering post of a folding type electric kickboard using a linear actuator according to the present invention. FIG. 9 is a diagram showing the folding operation of the steering post of the folding type electric kickboard using the linear actuator according to the present invention. FIG. 10 is a diagram showing the “steering shaft housing support base 30-3” of the folding type electric kickboard using the linear actuator according to the present invention.

The folding type electric kickboard according to the present invention includes a frame folding portion 30 to which a front wheel W1 and a rear wheel W2 are mounted, a steering post 40-5 connected to the front wheel W1, and a steering handle portion 40 formed on the upper portion of the steering post 40-5.

Direct current (DC) in-wheel hub motors used in electric kickboards are generally generalized, and their structure does not fall within the scope of the claims of this patent. However, the in-wheel hub motor is shown to be attached to the front wheel for explanation of drawings.

The in-wheel hub motor can of course be attached to the rear wheel so that it can be driven, and can also be used by being attached to the front wheel w1 and the rear wheel w2 at the same time.

A battery power pack 20 is equipped with a battery 20-3 and a controller 20-4 inside, and is provided with a “V”-shaped bracket 20-5 on a back side, and is attached to a latch member 41 provided on the steering post 40-5.

The latch member 41 is formed with hanger grooves 41-2 on both sides so that the battery power pack 20 can be mounted on both sides. Therefore, the number of battery power packs 20 can be increased, the output can be improved, and the kickboard can run for a long time.

The frame folding portion 30 is a foothold, and is divided into one side frame 30-1 and the other side frame 30-2.

One side frame 30-1 has a steering shaft housing support base 30-3 attached to one side of the upper surface thereof, which is coupled to the steering shaft housing 40-4. A rear wheel shock absorber support 30-4, a rear wheel

speed absorber 30-5 and a rear wheel mounting bracket 30-6 are mounted on one side of the other frame 30-2.

A plurality of hinges 6 are formed at a boundary between the one side frame 30-1 and the other side frame 30-2.

A folding electric cylinder 30-8 is attached at a center in a horizontal direction of the rear surface portion of the one side frame 30-1, the connecting member 5 is connected to a tip of a cylinder rod of the folding electric cylinder 30-8 with a shaft pin 52, and the connecting member 5 is attached to the other side frame 30-2.

A connecting base mounting portion 54 having a plurality of coupling holes 55 formed therein is formed on the bottom surface of the other side frame 30-2 so that a position where the connecting member 5 is fixed can be set.

Therefore, after aligning a through hole of the connecting member 5 with one of the coupling holes 55, the shaft pin 52 can be fastened to mount the connecting member 5. By making it possible to change the mounting position depending on necessity of a user, it is possible to appropriately set an angle at which the other side frame 30-2 is bent when the cylinder rod of the folding electric cylinder 30-8 is pulled out or pulled in.

When the cylinder rod of the folding electric cylinder 30-8 is advanced, since the connecting member 30-9 is fixed to the other side frame 30-2, the one side frame 30-1 and the other side frame 30-2 becomes a horizontal state while being unfolded (see FIGS. 1(a) and 2).

Conversely, when the cylinder rod of the electric cylinder 30-8 is pulled in, since the connecting member 30-9 pulls the other side frame 30-2, a torsion spring 65, which receives the torsional stress in a rotational direction to a torsion axis of the hinge 6 with the pulling force of the folding electric cylinder, activates the auxiliary bending elastic restoring energy, and the one side frame 30-1 and the other side frame 30-2 are bent into an “A” shape (see FIG. 1(b) and FIG. 5).

As shown in FIG. 7, the hinge 6 is configured to include a pair of female hinge portions 62 which is formed at the bottom of the front end of the other side frame 30-2 and are disposed to be spaced apart, a male hinge portion 63 which is formed at the lower portion of the rear end of the one side frame 30-1 to correspond thereto and sandwiched between the female hinge portions 62, an shaft pin 64 coupled through the female hinge portion 62 and the male hinge portion 63, and a torsion spring 65 that is coupled to the shaft pin 64 to exhibit torsional elasticity of the female hinge portion 62 and the male hinge portion 63. With the rod pulling force of the folding electric cylinder 30-8 and the torsion force of the torsion spring 65, the one side frame 30-1 and the other side frame 30-2 assist to be easily bent folded.

A thin iron plate (not shown) that abuts on a plate-like electromagnet 34 so as to be magnetically attracted by the magnetic force generated when electricity is applied may be provided at a portion in which the one side frame 30-1 and the other side frame 30-2 abut on each other.

Therefore, when the electric kickboard is driven with the one side frame 30-1 and the other side frame 30-2 being horizontal, the plate-like electromagnet 34 can hold the electric kickboard more stably.

Here, the plate-like electromagnet 34 is preferentially de-energized and its magnetic force is turned off at the moment when the wired or wireless switch of the electric cylinder 30-8 is operated to fold the frame of the electric kickboard into an ‘A’ shape. Such an operation is controlled by a series of controllers.

On the other hand, as shown in FIG. 8, a steering handle post portion 40-5 is formed above the steering post 40-5.

A steering shaft 40-2 to which a front wheel shock absorber 40-1 is mounted is included in the lower portion of the steering handle post portion 40-5. The steering shaft 40-2 is coupled with a bearing and inserted into the steering shaft housing 40-4.

The steering shaft housing 40-4 has a structure in which left and right steering shaft housing supports 30-3 are each provided. Here, as shown in FIG. 10, a hinge hole 310 and a fitting groove 330 are formed at the tip of the steering shaft housing support base 30-3, and a hinge pin 406 is coupled to the hinge hole 310 and coupled in a hinged state, and coupled to the fitting groove 330 with the tightening bolt 332 to tighten and untighten one surface of the tightening groove formed in the steering shaft housing support base 30-3.

The tilting electric cylinder 40-9 rod connected to the steering shaft housing 40-4 is moved forward and backward to cause the steering shaft housing to lie down or stand up, and thus, an axial axis 40-2 and a steering post 40-5 on which the steering shaft housing lies down or stands up are included.

One end of the steering shaft housing support base 30-3 is connected to one side frame 30-1, and the other side is connected to a hinge hole 310 in which left and right hinge pins 40-6 are coupled to the steering shaft housing 40-4. A plurality of fitting grooves 330 are formed below the hinge pin 40-6.

A plurality of tightening bolts 332 coupled to a plurality of fitting grooves 330 are screwed to the outer surface of the steering shaft housing 40-4.

Here, the tightening bolt is not shown in the drawing, but is loosened instantly by a 180° rotational operation of the electric rotary solenoid rod. Here, after folding the frame into the “A” shape, the rotation of the electric rotary solenoid rod is reversed to tighten the tightening bolt 332. This operation is controlled by a series of controller programs.

Therefore, as shown in FIG. 10(b), when the plurality of tightening bolts 332 are loosened by 180° by the rotational force of the electric rotary solenoid, the tightening bolts 332 tighten one surface of the tightening groove formed in the steering shaft housing support base is partially released, and thus, the tilting electric cylinder 40-9 can lay the steering post 40-5 and the steering shaft housing 40-4 about the hinge pin 40-6 to reduce the volume.

Conversely, as shown in FIG. 10(a), after the steering post 40-5 and the steering shaft housing 40-4 are erected and the tightening bolt 332 is inserted into the fitting groove 330, the tightening bolt 332 is reversed by 180° by the rotational force of the electric rotary solenoid. One side of each tightening groove formed in the steering shaft housing support base is tightened to fix the steering post 40-5, and then safe driving can be performed.

A tilting electric cylinder 40-9 which connects the steering post 40-5 and the steering shaft housing support base 30-3 is included.

The upper portion of the tilting electric cylinder 40-9 is coupled to a bracket protruding from the outer peripheral surface of the steering shaft housing 40-4 with a cylinder tip pin 40-10, and the lower portion of the tilting electric cylinder 40-9 is coupled to the cylinder lower end pin 40-1 after being inserted into a joint 306 formed at the front end of the one side frame 30-1.

Therefore, the forward and backward operations of the cylinder rod of the tilting electric cylinder 40-9 causes the steering shaft housing 40-4 to be tilted or erected at a certain angle, thereby making it possible to make the steering post 40-5 stand down or up.

When the cylinder rod of the tilting electric cylinder 40-9 is pulled in to fold the steering shaft housing 40-4, the steering post 40-5 inserted into the steering shaft housing is also rotated around the hinge pin 40-6 and lie at a certain angle.

Various modifications and variations may be made without departing from the spirit and scope of the invention. Accordingly, the appended claims shall include such modifications or variations insofar as they fall within the spirit of the present invention.

1. A folding type electric kickboard using a linear actuator which comprises a frame folding portion (30) to which a front wheel (W1) and a rear wheel (W2) are mounted, a steering post (40-5) connected to the front wheel (W1), and a handle formed on the top of the steering post (40-5),
wherein the frame folding portion (30) comprises one side frame (30-1) and the other side frame (30-2),
a hinge (6) is formed at a boundary between the one side frame (30-1) and the other side frame (30-2),
a folding electric cylinder (30-8) is attached to the one side frame (30-1) as a center of a rear side in a horizontal direction, and a connecting member (5) is connected to a tip of a cylinder rod of the folding electric cylinder (30-8) with an axial pin (52),
the connecting member (5) is attached to the other side frame (30-2), and
a bottom surface of the other side frame (30-2) is formed with a connecting base mounting portion (54) having a large number of coupling holes (55) so that a position to which the connecting member (5) is fixed is settable.

2. The folding type electric kickboard using the linear actuator according to claim 1,
wherein the hinge (6) comprises
a pair of female hinge portions (62) which are formed at a lower portion of a front end of the other side frame (30-2) and spaced apart from each other;
a male hinge portion (63) which is formed at a lower portion of a rear end of the one side frame (30-1) and sandwiched between the female hinge portions (62);
a shaft pin (64) which penetrates the female hinge portion (62) and the male hinge portion (63) and is coupled; and
a torsion spring (65) which is coupled to the shaft pin (64) to exhibit torsional elasticity of the female hinge portion (62) and the male hinge portion (63).

3. The folding type electric kickboard using the linear actuator according to claim 1,
wherein a plate-like electromagnet (34) so as to be magnetically attracted by the magnetic force of the plate-like electromagnet (34) in which a magnetic force is turned on and off by electric current and blocking is included in a portion in which the one side frame (30-1) and the other side frame (30-2) abut on each other.

4. The folding type electric kickboard using the linear actuator according to claim 1, further comprising:
a steering shaft housing (40-4) mounted to the lower portion of the steering post (40-5);
a steering shaft housing support base (30-3) which has one side frame (30-1) attached to one side of the upper surface, and is coupled to the steering shaft housing (40-4),
wherein the steering shaft housing support base (30-3) is connected to the frame (30-1) at one end, and the hinge pin (40-6) is coupled to the other end on the left and right sides of the steering shaft housing (40-4) in conjunction with the hinge hole (310),
a plurality of fitting grooves (330) are formed in the lower portion of the hinge pin (40-6), and
a plurality of tightening bolts (332) coupled to the plurality of fitting grooves (330) and the steering shaft housing support base (30-3) are comprised.

5. The folding type electric kickboard using the linear actuator according to claim 4,
wherein the steering shaft housing lies down or stands up by forward and backward operation of the tilting electric cylinder (40-9) rod connected to the steering shaft housing (40-4), and thus a steering shaft (40-2) and a steering post (40-5) which lies down or stands up are comprised,
an upper portion of the tilting electric cylinder (40-9) is coupled to a bracket protruding from an outer peripheral surface of the steering shaft housing (40-4) with a cylinder tip pin (40-10), and
a lower portion of the tilting electric cylinder (40-9) is inserted into a coupling portion (306) formed at the front end of the one side frame (30-1) and coupled with a cylinder lower end pin (40-11),
so that the steering post (40-5) is folded by the forward and backward operations of the cylinder rod of the tilting electric cylinder (40-9).
